(19) United States
(12) Patent Application Publication
(10) Pub. No.: US 2017/0066965 A1
(43) Pub. Date: Mar. 9, 2017

(54) HIGHLY LUMINESCENT CADMIUM-FREE NANOCRYSTALS WITH BLUE EMISSION

(71) Applicant: NANOSYS, Inc., Milpitas, CA (US)

(72) Inventors: Jonathan TRUSKIER, Berkeley, CA (US); Shihai KAN, San Jose, CA (US)

(21) Appl. No.: 15/259,889

(22) Filed: Sep. 8, 2016

Related U.S. Application Data
(60) Provisional application No. 62/216,093, filed on Sep. 9, 2015.

(51) Int. Cl. C09K 11/88; C09K 11/02; C09K 11/56

(52) U.S. Cl. CPC C09K 11/883; C09K 11/565; C09K 11/025; B82Y 40/00

(57) ABSTRACT

Highly luminescent nanostructures comprising a ZnSe core and ZnS shell layers, particularly highly luminescent quantum dots, are provided. The nanostructures have high photoluminescence quantum yields and in certain embodiments emit light at particular wavelengths and have a narrow size distribution. Processes for producing such highly luminescent nanostructures and techniques for shell synthesis are also provided.

### CROSS-REFERENCE TO RELATED APPLICATION

This application claims priority benefit of U.S. Provisional Application No. 62/216,093, filed Sep. 9, 2015, which is hereby incorporated by reference in its entirety.

### BACKGROUND OF THE INVENTION

Field of the Invention

The invention pertains to the field of nanotechnology. More particularly, the invention relates to highly luminescent nanostructures, particularly highly luminescent nanostructures comprising a ZnSe core and ZnS shell layers. The invention also relates to methods of producing such nanostructures.

Background Art

Semiconductor nanostructures can be incorporated into a variety of electronic and optical devices. The electrical and optical properties of such nanostructures vary, e.g., depending on their composition, shape, and size. For example, size-tunable properties of semiconductor nanoparticles are of great interest for applications such as light emitting diodes (LEDs), lasers, and biomedical labeling. Highly luminescent nanostructures are particularly desirable for such applications.

To exploit the full potential of nanostructures in applications such as LEDs and displays, the nanostructures need to simultaneously meet five criteria: narrow and symmetric emission spectra, high photoluminescence (PL) quantum yields (QYs), high optical stability, eco-friendly materials, and low-cost methods for mass production. Most previous studies on highly emissive and color-tunable quantum dots have concentrated on materials containing cadmium, mercury, or lead. Wang, A., et al., Nanoscale 7:2951-2959 (2015). But, there are increasing concerns that toxic materials such as cadmium, mercury, or lead would pose serious threats to human health and the environment and the European Union's Restriction of Hazardous Substances rules ban any consumer electronics containing more than trace amounts of these materials. Therefore, there is a need to produce materials that are free of cadmium, mercury, and lead for the production of LEDs and displays.

CdSe-based nanostructures with high quantum yield and a broad emission spanning the entire visible spectral region have been produced; however, the intrinsic toxicity of cadmium raises environmental concerns which limit the future application of such cadmium-based nanoparticles. InP-based nanostructures are the best-known substitute for CdSe-based materials; however, due to their relatively small bandgap, In—P based nanostructures can only produce red and green luminescence. In addition, high quantum yield InP nanostructures have been difficult to obtain.

ZnSe-based nanostructures are ideal for generating blue luminescence due to their large bandgap. Methods for simply and reproducibly producing highly luminescent nanostructures, particularly highly luminescent ZnSe nanostructures, are thus desirable. Among other aspects, the present invention provides such methods. A complete understanding of the invention will be obtained upon review of the following.

### BRIEF SUMMARY OF THE INVENTION

The present invention provides a nanostructure comprising a core surrounded by a shell, wherein the core comprises two or more layers comprising ZnSe; and the shell comprises two or more layers comprising ZnS.

In some embodiments, the emission wavelength of the nanostructure is between 400 nm and 460 nm. In some embodiments, the emission wavelength of the nanostructure is between 430 nm and 440 nm. In some embodiments, the emission wavelength of the nanostructure is between 435 nm and 438 nm.

In some embodiments, the core comprises between five and eight layers. In some embodiments, the core comprises seven layers.

In some embodiments, the shell comprises between two and five layers. In some embodiments, the shell comprises three layers.

In some embodiments, the nanostructure has a particle size between 5 nm and 10 nm. In some embodiments, the nanostructure has a particle size between 7 nm and 8 nm.

In some embodiments, the photoluminescence quantum yield of the nanostructure is between 80% and 99%. In some embodiments, the photoluminescence quantum yield of the nanostructure is between 85% and 96%.

In some embodiments, the thickness of each layer comprising ZnSe is between 0.2 nm and 0.5 nm. In some embodiments, the thickness of each layer comprising ZnSe is between 0.3 nm and 0.4 nm.

In some embodiments, the thickness of each layer comprising ZnS is between 0.2 nm and 0.5 nm. In some embodiments, the thickness of each layer comprising ZnS is between 0.3 nm and 0.4 nm.

In some embodiments, the nanostructure is a quantum dot.

In some embodiments, the nanostructure is embedded in a matrix.

In some embodiments, the nanostructure is free of cadmium.

In some embodiments, the nanostructure further comprises one or more layers comprising ZnSeₓS₁₋ₓ, wherein 0<x<1, between the core and the shell.

The present invention provides a method of producing a multi-layered nanostructure comprising:
(a) combining a zinc source and a selenium source to produce a reaction mixture comprising a ZnSe nucleus;
(b) contacting the reaction mixture obtained in (a) with a solution comprising a zinc source and a selenium source;
(c) repeating (b) to provide a multi-layered nanostructure.

In some embodiments, the zinc source is a dialkyl zinc. In some embodiments, the zinc source is selected from the group consisting of dimethylzinc and diethylzinc.

In some embodiments, the selenium source is hydrogen selenide.

In some embodiments, the zinc source, the selenium source, an organic phosphine ligand, and an amine ligand are combined to form the reaction mixture.

In some embodiments, the zinc source and the selenium source are combined at a temperature between 250° C. and 320° C. In some embodiments, the zinc source and the selenium source are combined at a temperature of about 300° C.

In some embodiments, the zinc source contacted with the ZnSe nucleus is the same as the zinc source used to produce the ZnSe nucleus.

In some embodiments, the selenium source is elemental selenium.

In some embodiments, the ZnSe nucleus is contacted with a solution comprising a zinc source and selenium source at a temperature between 250° C. and 320° C. In some embodiments, the ZnSe nucleus is contacted with a solution comprising a zinc source and a selenium source at a temperature of about 280° C.

In some embodiments, the ZnSe nucleus is contacted with a solution comprising a zinc source and a selenium source and the contacting is repeated between four and eight times. In some embodiments, the ZnSe nucleus is contacted with a solution comprising a zinc source and a selenium source and the contacting is repeated five times.

In some embodiments, the ZnSe nucleus is contacted with a solution comprising a zinc source and a selenium source for between 5 minutes and 15 minutes before repeating.

In some embodiments, a zinc source, a selenium source, and at least one ligand are contacted to produce a reaction mixture comprising a ZnSe nucleus. In some embodiments, the at least one ligand is an alkyl amine. In some embodiments, the at least one ligand is selected from the group consisting of dodecylamine, oleylamine, hexadecylamine, and octadecylamine. In some embodiments, the at least one ligand is an organic phosphine. In some embodiments, the at least one ligand is selected from the group consisting of trioctylphosphine oxide, trioctylphosphine, diphenylphosphine, triphenylphosphine oxide, and tributylphosphine oxide. In some embodiments, the at least one ligand is trioctylphosphine or diphenylphosphine. In some embodiments, at least three ligands are contacted with the zinc source and selenium source.

In some embodiments, diethyl zinc, elemental selenium, and the ligands oleylamine, trioctylphosphine, and diphenylphosphine are contacted and the contacting is repeated five times.

The present invention provides a method of producing a multi-layered core/shell nanostructure comprising:
(d) combining a multi-layered ZnSe core nanostructure with a solution comprising a zinc carboxylate source and a sulfur source;
(e) repeating (d) to provide a multi-layered core/shell nanostructure.

In some embodiments, the zinc carboxylate source is zinc stearate or zinc oleate.

In some embodiments, the multi-layered ZnSe core nanostructure is combined with the solution at a temperature between 250° C. and 320° C. In some embodiments, the multi-layered ZnSe core nanostructure is combined with the solution at a temperature of about 310° C.

In some embodiments, the sulfur source is selected from the group consisting of elemental sulfur, octanethiol, and dodecanethiol. In some embodiments, the sulfur source is elemental sulfur.

In some embodiments, the combining of the core with the solution comprising a zinc carboxylate source and a sulfur source is repeated between one and three times. In some embodiments, the combining of the core with the solution comprising a zinc carboxylate source and a sulfur source is repeated two times.

In some embodiments, the combining of the core with the solution comprising a zinc carboxylate source and a sulfur source is maintained for between 5 minutes and 15 minutes before repeating.

In some embodiments, the combining of the core with the solution comprising a zinc carboxylate source and a sulfur source further comprises at least one ligand. In some embodiments, the at least one ligand is an organic phosphine. In some embodiments, the at least one ligand is selected from the group consisting of trioctylphosphine oxide, trioctylphosphine, diphenylphosphine, triphenylphosphine oxide, and tributylphosphine oxide. In some embodiments, the at least one ligand is trioctylphosphine or trioctylphosphine oxide.

The present invention provides a method of producing a multi-layered core/buffer layer/shell nanostructure comprising:
(d) combining the multi-layered ZnSe core with a solution comprising a zinc source, a selenium source, and a sulfur source;
(e) optionally repeating (d) to provide a multi-layered core/buffer layer;
(f) contacting the multi-layered core/buffer layer of (e) with a solution comprising a zinc carboxylate source and a sulfur source;
(g) repeating (f) to provide a multi-layered core/buffer layer/shell nanostructure.

### BRIEF DESCRIPTION OF THE DRAWINGS

FIG. 1 shows a transmission electron micrograph of the ZnSe cores after purification. As shown in the micrograph, the ZnSe cores have a rod-shaped morphology.

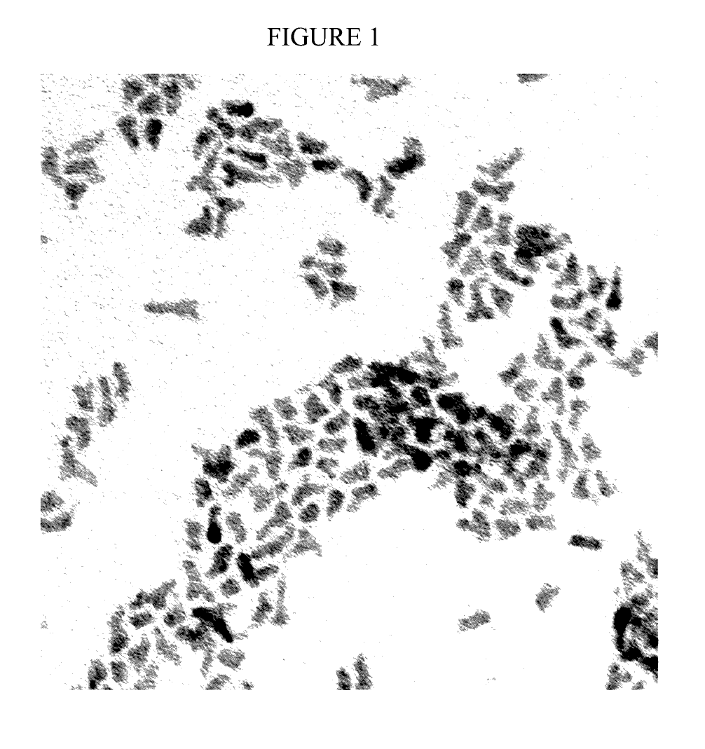

FIG. 2 shows a transmission electron micrograph of the ZnSe cores after heating in a flask in the presence of Zn carboxylate and a carboxylic acid. As shown in the micrograph, the etching and redeposition of material from the ZnSe cores that is caused by the Zn carboxylate and carboxylic acid at elevated temperature results in spherical nanocrystals.

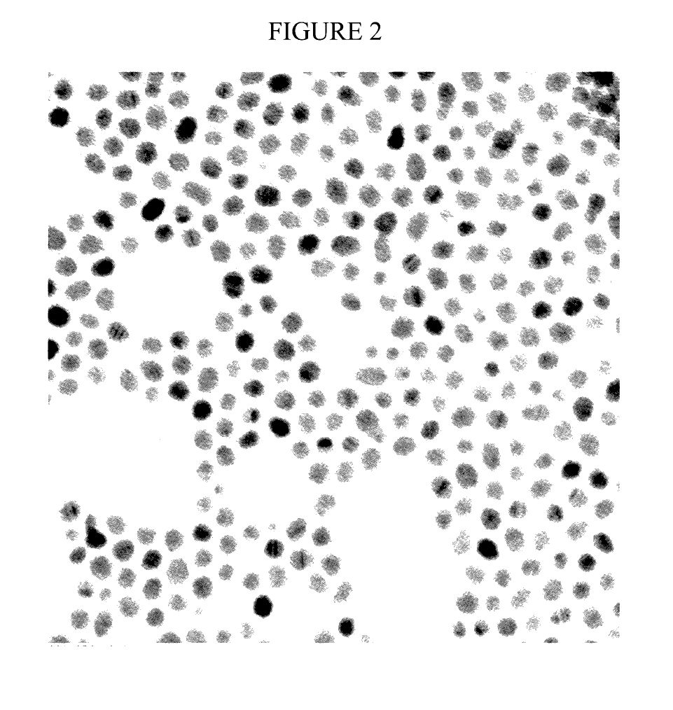

FIG. 3A and FIG. 3B show graphs for calculating the size of the ZnSe cores based on quantum confinement. The bandgap absorption wavelength versus particle diameter curve was divided into two segments—a segment at a wavelength below 400 nm (3A) and a segment at a wavelength equal to or greater than 400 nm (3B)—and each segment was fitted to a polynomial equation. The resulting polynomial equations were used to calculate the diameter of the ZnSe core (using wavelength as the variable).

FIG. 4 shows a graph of optical density versus wavelength of the ZnSe cores. The concentration of the ZnSe cores can be determined by the absorption coefficient of bulk ZnSe at 350 nm. As shown in the graph, the bulk absorption coefficient of ZnSe is 8.08 mg/mL (with a 1 cm path length).

### DETAILED DESCRIPTION OF THE INVENTION

### Definitions

Unless defined otherwise, all technical and scientific terms used herein have the same meaning as commonly understood by one of ordinary skill in the art to which the invention pertains. The following definitions supplement those in the art and are directed to the current application and are not to be imputed to any related or unrelated case, e.g., to any commonly owned patent or application. Although any methods and materials similar or equivalent to those described herein can be used in the practice for testing of the present invention, the preferred materials and methods are described herein. Accordingly, the terminology used herein is for the purpose of describing particular embodiments only, and is not intended to be limiting.

As used in this specification and the appended claims, the singular forms “a,” “an” and “the” include plural referents unless the context clearly dictates otherwise. Thus, for example, reference to “a nanostructure” includes a plurality of such nanostructures, and the like.

The term “about” as used herein indicates the value of a given quantity varies by +/−10% of the value, or optionally +/−5% of the value, or in some embodiments, by +/−1% of the value so described. For example, “about 100 nm” encompasses a range of sizes from 90 nm to 110 nm, inclusive.

A “nanostructure” is a structure having at least one region or characteristic dimension with a dimension of less than about 500 nm. In some embodiments, the nanostructure has a dimension of less than about 200 nm, less than about 100 nm, less than about 50 nm, less than about 20 nm, or less than about 10 nm. Typically, the region or characteristic dimension will be along the smallest axis of the structure. Examples of such structures include nanowires, nanorods, nanotubes, branched nanostructures, nanotetrapods, tripods, bipods, nanocrystals, nanodots, quantum dots, nanoparticles, and the like. Nanostructures can be, e.g., substantially crystalline, substantially monocrystalline, polycrystalline, amorphous, or a combination thereof. In some embodiments, each of the three dimensions of the nanostructure has a dimension of less than about 500 nm, less than about 200 nm, less than about 100 nm, less than about 50 nm, less than about 20 nm, or less than about 10 nm.

The term “heterostructure” when used with reference to nanostructures refers to nanostructures characterized by at least two different and/or distinguishable material types. Typically, one region of the nanostructure comprises a first material type, while a second region of the nanostructure comprises a second material type. In certain embodiments, the nanostructure comprises a core of a first material and at least one shell of a second (or third etc.) material, where the different material types are distributed radially about the long axis of a nanowire, a long axis of an arm of a branched nanowire, or the center of a nanocrystal, for example. A shell can but need not completely cover the adjacent materials to be considered a shell or for the nanostructure to be considered a heterostructure; for example, a nanocrystal characterized by a core of one material covered with small islands of a second material is a heterostructure. In other embodiments, the different material types are distributed at different locations within the nanostructure; e.g., along the major (long) axis of a nanowire or along a long axis of arm of a branched nanowire. Different regions within a heterostructure can comprise entirely different materials, or the different regions can comprise a base material (e.g., silicon) having different dopants or different concentrations of the same dopant.

As used herein, the “diameter” of a nanostructure refers to the diameter of a cross-section normal to a first axis of the nanostructure, where the first axis has the greatest difference in length with respect to the second and third axes (the second and third axes are the two axes whose lengths most nearly equal each other). The first axis is not necessarily the longest axis of the nanostructure; e.g., for a disk-shaped nanostructure, the cross-section would be a substantially circular cross-section normal to the short longitudinal axis of the disk. Where the cross-section is not circular, the diameter is the average of the major and minor axes of that cross-section. For an elongated or high aspect ratio nanostructure, such as a nanowire, the diameter is measured across a cross-section perpendicular to the longest axis of the nanowire. For a spherical nanostructure, the diameter is measured from one side to the other through the center of the sphere.

The terms “crystalline” or “substantially crystalline,” when used with respect to nanostructures, refer to the fact that the nanostructures typically exhibit long-range ordering across one or more dimensions of the structure. It will be understood by one of skill in the art that the term “long range ordering” will depend on the absolute size of the specific nanostructures, as ordering for a single crystal cannot extend beyond the boundaries of the crystal. In this case, “long-range ordering” will mean substantial order across at least the majority of the dimension of the nanostructure. In some instances, a nanostructure can bear an oxide or other coating, or can be comprised of a core and at least one shell. In such instances it will be appreciated that the oxide, shell(s), or other coating can but need not exhibit such ordering (e.g. it can be amorphous, polycrystalline, or otherwise). In such instances, the phrase “crystalline,” “substantially crystalline,” “substantially monocrystalline,” or “monocrystalline” refers to the central core of the nanostructure (excluding the coating layers or shells). The terms “crystalline” or “substantially crystalline” as used herein are intended to also encompass structures comprising various defects, stacking faults, atomic substitutions, and the like, as long as the structure exhibits substantial long range ordering (e.g., order over at least about 80% of the length of at least one axis of the nanostructure or its core). In addition, it will be appreciated that the interface between a core and the outside of a nanostructure or between a core and an adjacent shell or between a shell and a second adjacent shell may contain non-crystalline regions and may even be amorphous. This does not prevent the nanostructure from being crystalline or substantially crystalline as defined herein.

The term “monocrystalline” when used with respect to a nanostructure indicates that the nanostructure is substantially crystalline and comprises substantially a single crystal. When used with respect to a nanostructure heterostructure comprising a core and one or more shells, “monocrystalline” indicates that the core is substantially crystalline and comprises substantially a single crystal.

A “nanocrystal” is a nanostructure that is substantially monocrystalline. A nanocrystal thus has at least one region or characteristic dimension with a dimension of less than about 500 nm. In some embodiments, the nanocrystal has a dimension of less than about 200 nm, less than about 100 nm, less than about 50 nm, less than about 20 nm, or less than about 10 nm. The term “nanocrystal” is intended to encompass substantially monocrystalline nanostructures comprising various defects, stacking faults, atomic substitutions, and the like, as well as substantially monocrystalline nanostructures without such defects, faults, or substitutions. In the case of nanocrystal heterostructures comprising a core and one or more shells, the core of the nanocrystal is typically substantially monocrystalline, but the shell(s) need not be. In some embodiments, each of the three dimensions of the nanocrystal has a dimension of less than about 500 nm, less than about 200 nm, less than about 100 nm, less than about 50 nm, less than about 20 nm, or less than about 10 nm.

The term “quantum dot” (or “dot”) refers to a nanocrystal that exhibits quantum confinement or exciton confinement. Quantum dots can be substantially homogenous in material properties, or in certain embodiments, can be heterogeneous, e.g., including a core and at least one shell. The optical properties of quantum dots can be influenced by their particle size, chemical composition, and/or surface composition, and can be determined by suitable optical testing available in the art. The ability to tailor the nanocrystal size, e.g., in the range between about 1 nm and about 15 nm, enables photoemission coverage in the entire optical spectrum to offer great versatility in color rendering.

A “ligand” is a molecule capable of interacting (whether weakly or strongly) with one or more faces of a nanostructure, e.g., through covalent, ionic, van der Waals, or other molecular interactions with the surface of the nanostructure.

“Photoluminescence quantum yield” is the ratio of photons emitted to photons absorbed, e.g., by a nanostructure or population of nanostructures. As known in the art, quantum yield is typically determined by a comparative method using well-characterized standard samples with known quantum yield values.

As used herein, the term “layer” refers to material deposited onto the core or onto previously deposited layers and that result from a single act of deposition of the core or shell material. The exact thickness of a layer is dependent on the material. For example, a ZnSe layer may have a thickness of about 0.33 nm and a ZnS layer may have a thickness of about 0.31 nm.

As used herein, the term “full width at half-maximum” (FWHM) is a measure of the size distribution of quantum dots. The emission spectra of quantum dots generally have the shape of a Gaussian curve. The width of the Gaussian curve is defined as the FWHM and gives an idea of the size distribution of the particles. A smaller FWHM corresponds to a narrower quantum dot nanocrystal size distribution. FWHM is also dependent upon the emission wavelength maximum.

“Alkyl” as used herein refers to a straight or branched, saturated, aliphatic radical having the number of carbon atoms indicated. In some embodiments, the alkyl is C₁₋₂ alkyl, C₁₋₃ alkyl, C₁₋₄ alkyl, C₁₋₅ alkyl, C₁₋₆ alkyl, C₁₋₇ alkyl, C₁₋₈ alkyl, C₁₋₉ alkyl, C₁₋₁₀ alkyl, C₁₋₁₂ alkyl, C₁₋₁₄ alkyl, C₁₋₁₆ alkyl, C₁₋₁₈ alkyl, C₁₋₂₀ alkyl, C₈₋₂₀ alkyl, C₁₂₋₂₀ alkyl, C₁₄₋₂₀ alkyl, C₁₆₋₂₀ alkyl, or C₁₈₋₂₀ alkyl. For example, C₁₋₆ alkyl includes, but is not limited to, methyl, ethyl, propyl, isopropyl, butyl, isobutyl, sec-butyl, tert-butyl, pentyl, isopentyl, and hexyl. In some embodiments, the alkyl is octyl, nonyl, decyl, undecyl, dodecyl, tridecyl, tetradecyl, pentadecyl, hexadecyl, heptadecyl, octadecyl, nonadecyl, or icosanyl.

Unless clearly indicated otherwise, ranges listed herein are inclusive.

A variety of additional terms are defined or otherwise characterized herein.

### Production of Nanostructures

Methods for colloidal synthesis of a variety of nanostructures are known in the art. Such methods include techniques for controlling nanostructure growth, e.g., to control the size and/or shape distribution of the resulting nanostructures.

In a typical colloidal synthesis, semiconductor nanostructures are produced by rapidly injecting precursors that undergo pyrolysis into a hot solution (e.g., hot solvent and/or surfactant). The precursors can be injected simultaneously or sequentially. The precursors rapidly react to form nuclei. Nanostructure growth occurs through monomer addition to the nuclei, typically at a growth temperature that is lower than the injection/nucleation temperature.

Surfactant molecules interact with the surface of the nanostructure. At the growth temperature, the surfactant molecules rapidly adsorb and desorb from the nanostructure surface, permitting the addition and/or removal of atoms from the nanostructure while suppressing aggregation of the growing nanostructures. In general, a surfactant that coordinates weakly to the nanostructure surface permits rapid growth of the nanostructure, while a surfactant that binds more strongly to the nanostructure surface results in slower nanostructure growth. The surfactant can also interact with one (or more) of the precursors to slow nanostructure growth.

Nanostructure growth in the presence of a single surfactant typically results in spherical nanostructures. Using a mixture of two or more surfactants, however, permits growth to be controlled such that non-spherical nanostructures can be produced, if, for example, the two (or more) surfactants adsorb differently to different crystallographic faces of the growing nanostructure.

A number of parameters are thus known to affect nanostructure growth and can be manipulated, independently or in combination, to control the size and/or shape distribution of the resulting nanostructures. These include, e.g., temperature (nucleation and/or growth), precursor composition, time-dependent precursor concentration, ratio of the precursors to each other, surfactant composition, number of surfactants, and ratio of surfactant(s) to each other and/or to the precursors.

Synthesis of Group II-VI nanostructures has been described, e.g., in U.S. Pat. Nos. 6,225,198, 6,322,901, 6,207,229, 6,607,829, 7,060,243, 7,374,824, 6,861,155, 7,125,605, 7,566,476, 8,158,193, and 8,101,234 and US patent application publications 2011/0262752 and 2011/0263062.

Although Group II-VI nanostructures such as CdSe/CdS/ZnS core/shell quantum dots can exhibit desirable luminescence behavior, as noted above, issues such as the toxicity of cadmium limit the applications for which such nanostructures can be used. Less toxic alternatives with favorable luminescence properties are thus highly desirable. Group III-V nanostructures in general and InP-based nanostructures in particular, offer the best known substitute for cadmium-based materials due to their compatible emission range; however, blue luminescence cannot be achieved using InP-based nanostructures due to their relatively small bandgap.

In some embodiments, the nanostructures are free from cadmium. As used herein, the term “free of cadmium” is intended that the nanostructures contain less than 100 ppm by weight of cadmium. The Restriction of Hazardous Substances (RoHS) compliance definition requires that there must be no more than 0.01% (100 ppm) by weight of cadmium in the raw homogeneous precursor materials. The cadmium level in the Cd-free nanostructures of the present invention is limited by the trace metal concentration in the precursor materials. The trace metal (including cadmium) concentration in the precursor materials for the Cd-free nanostructures, is measured by inductively coupled plasma mass spectroscopy (ICP-MS) analysis, and are on the parts per billion (ppb) level. In some embodiments, nanostructures that are “free of cadmium” contain less than about 50 ppm, less than about 20 ppm, less than about 10 ppm, or less than about 1 ppm of cadmium.

In one aspect, the present invention overcomes the above noted difficulties (e.g., low quantum yield) by providing methods for the two-step growth of a layered ZnSe/ZnS nanostructure. Compositions related to the methods of the invention are also featured, including highly luminescent nanostructures with high quantum yields and narrow size distributions.

### Production of the ZnSe Core

The nanostructure comprises a ZnSe core and a ZnS shell. In some embodiments, the nanostructure is a ZnSe/ZnS core/shell quantum dot.

As used herein, the term “nucleation phase” refers to the formation of a ZnSe core nucleus. As used herein, the term “growth phase” refers to the growth process of applying additional layers of ZnSe to the core nucleus.

In some embodiments, the ZnSe core comprises more than one layer of ZnSe. In some embodiments, the number of ZnSe layers in the ZnSe core is between 5 and 12, between 5 and 11, between 5 and 10, between 5 and 9, between 5 and 8, between 5 and 7, between 5 and 6, between 6 and 12, between 6 and 11, between 6 and 10, between 6 and 9, between 6 and 8, between 6 and 7, between 7 and 12, between 7 and 11, between 7 and 10, between 7 and 9, between 7 and 8, between 8 and 12, between 8 and 11, between 8 and 10, between 8 and 9, between 9 and 12, between 9 and 11, between 9 and 10, between 10 and 12, between 10 and 11, or between 11 and 12. In some embodiments, the ZnSe core comprises 7 layers of ZnSe.

The thickness of the ZnSe core layers can be controlled by varying the amount of precursor provided. For a given layer, at least one of the precursors is optionally provided in an amount whereby, when a growth reaction is substantially complete, a layer of a predetermined thickness is obtained. If more than one different precursor is provided, either the amount of each precursor can be so limited or one of the precursors can be provided in a limiting amount while the others are provided in excess.

The thickness of each ZnSe layer of the ZnSe core can be determined using techniques known to those of skill in the art. In some embodiments, the thickness of each layer is determined by comparing the diameter of the ZnSe core before and after the addition of each layer. In some embodiments, the diameter of the ZnSe core before and after the addition of each layer is determined by transmission electron microscopy. In some embodiments, each ZnSe layer has a thickness of between 0.05 nm and 2 nm, between 0.05 nm and 1 nm, between 0.05 nm and 0.5 nm, between 0.05 nm and 0.3 nm, between 0.05 nm and 0.1 nm, between 0.1 nm and 2 nm, between 0.1 nm and 1 nm, between 0.1 nm and 0.5 nm, between 0.1 nm and 0.3 nm, between 0.3 nm and 2 nm, between 0.3 nm and 1 nm, between 0.3 nm and 0.5 nm, between 0.5 nm and 2 nm, between 0.05 nm and 1 nm, or between 1 nm and 2 nm. In some embodiments, each ZnSe layer has an average thickness of about 0.31 nm.

In some embodiments, the present invention provides a method of producing a multi-layered nanostructure comprising:
(a) combining a zinc source and a selenium source to produce a reaction mixture comprising a ZnSe nucleus;
(b) contacting the reaction mixture obtained in (a) with a solution comprising a zinc source and a selenium source;
(c) repeating (c) to provide a multi-layered nanostructure.

In some embodiments, the zinc source is a dialkyl zinc compound. In some embodiments, the zinc source is diethylzinc, dimethylzinc, zinc acetate, zinc acetylacetonate, zinc iodide, zinc bromide, zinc chloride, zinc fluoride, zinc carbonate, zinc cyanide, zinc nitrate, zinc oxide, zinc peroxide, zinc perchlorate, or zinc sulfate. In some embodiments, the zinc source is diethylzinc or dimethylzinc. In some embodiments, the zinc source is diethylzinc.

In some embodiments, the selenium source is selected from trioctylphosphine selenide, tri(n-butyl)phosphine selenide, tri(sec-butyl)phosphine selenide, tri(tert-butyl)phosphine selenide, trimethylphosphine selenide, triphenylphosphine selenide, diphenylphosphine selenide, phenylphosphine selenide, cyclohexylphosphine selenide, octaselenol, dodecaselenol, selenophenol, elemental selenium, hydrogen selenide, bis(trimethylsilyl) selenide, and mixtures thereof. In some embodiments, the selenium source is elemental selenium.

In some embodiments, the core layers are synthesized in the presence of at least one nanostructure ligand. Ligands can, e.g., enhance the miscibility of nanostructures in solvents or polymers (allowing the nanostructures to be distributed throughout a composition such that the nanostructures do not aggregate together), increase quantum yield of nanostructures, and/or preserve nanostructure luminescence (e.g., when the nanostructures are incorporated into a matrix). In some embodiments, the ligand(s) for the core synthesis and for the shell synthesis are the same. In some embodiments, the ligand(s) for the core synthesis and for the shell synthesis are different. Following synthesis, any ligand on the surface of the nanostructures can be exchanged for a different ligand with other desirable properties. Examples of ligand are disclosed in US Patent Application Publication Nos. 2005/0205849, 2008/0105855, 2008/0118755, 2009/0065764, 2010/0140551, 2013/0345458, 2014/0151600, 2014/0264189, and 2014/0001405.

In some embodiments, ligands suitable for the synthesis of nanostructure cores, including ZnSe cores, are known by those of skill in the art. In some embodiments, the ligand is a fatty acid selected from lauric acid, caproic acid, myristic acid, palmitic acid, stearic acid, and oleic acid. In some embodiments, the ligand is an organic phosphine or an organic phosphine oxide selected from trioctylphosphine oxide (TOPO), trioctylphosphine (TOP), diphenylphosphine (DPP), triphenylphosphine oxide, and tributylphosphine oxide. In some embodiments, the ligand is an amine selected from dodecylamine, oleylamine, hexadecylamine, and octadecylamine. In some embodiments, the ligand is trioctylphosphine (TOP). In some embodiments, the ligand is oleylamine. In some embodiments, the ligand is diphenylphosphine.

In some embodiments, the core is produced in the presence of a mixture of ligands. In some embodiments, the core is produced in the presence of a mixture comprising 2, 3, 4, 5, or 6 different ligands. In some embodiments, the core is produced in the presence of a mixture comprising 3 different ligands. In some embodiments, the mixture of ligands comprises oleylamine, trioctylphosphine, and diphenylphosphine.

In some embodiments, in an initial nucleation phase, a zinc source is added to a mixture of ligand source and selenium source at a reaction temperature between 250° C. and 350° C., between 250° C. and 320° C., between 250° C. and 300° C., between 250° C. and 290° C., between 250° C. and 280° C., between 250° C. and 270° C., between 270° C. and 350° C., between 270° C. and 320° C., between 270° C. and 300° C., between 270° C. and 290° C., between 270° C. and 280° C., between 280° C. and 350° C., between 280° C. and 320° C., between 280° C. and 300° C., between 280° C. and 290° C., between 290° C. and 350° C., between 290° C. and 320° C., between 290° C. and 300° C., 300° C. and 350° C., between 300° C. and 320° C., or between 320° C. and 350° C. In some embodiments, a zinc source is added to a mixture of ligand source and selenium source at a reaction temperature of about 300° C.

In some embodiments, the reaction mixture after addition of the zinc source is maintained at an elevated temperature for between 2 and 20 minutes, between 2 and 15 minutes, between 2 and 10 minutes, between 2 and 8 minutes, between 2 and 5 minutes, between 5 and 20 minutes, between 5 and 15 minutes, between 5 and 10 minutes, between 5 and 8 minutes, between 8 and 20 minutes, between 8 and 15 minutes, between 8 and 10 minutes, between 10 and 20 minutes, between 10 and 15 minutes, or between 15 and 20 minutes.

In some embodiments, in a first growth phase, a solution comprising a zinc source and a selenium source are added to the reaction mixture. In some embodiments, the solution comprising a zinc source and a selenium source further comprises a ligand. In some embodiments, the solution comprising a zinc source and a selenium source is added to the reaction mixture at a reaction temperature between 250° C. and 350° C., between 250° C. and 320° C., between 250° C. and 300° C., between 250° C. and 290° C., between 250° C. and 280° C., between 250° C. and 270° C., between 270° C. and 350° C., between 270° C. and 320° C., between 270° C. and 300° C., between 270° C. and 290° C., between 270° C. and 280° C., between 280° C. and 350° C., between 280° C. and 320° C., between 280° C. and 300° C., between 280° C. and 290° C., between 290° C. and 350° C., between 290° C. and 320° C., between 290° C. and 300° C., 300° C. and 350° C., between 300° C. and 320° C., or between 320° C. and 350° C. In some embodiments, a zinc source is added to a mixture of ligand source and selenium source at a reaction temperature of about 280° C. The addition of the solution comprising a zinc source and a selenium source in the first growth phase creates a layer over the initial ZnSe core nucleus.

In some embodiments, the reaction mixture—after the first growth phase of a solution comprising a zinc source and a selenium source—is maintained at an elevated temperature for between 2 and 20 minutes, between 2 and 15 minutes, between 2 and 10 minutes, between 2 and 8 minutes, between 2 and 5 minutes, between 5 and 20 minutes, between 5 and 15 minutes, between 5 and 10 minutes, between 5 and 8 minutes, between 8 and 20 minutes, between 8 and 15 minutes, between 8 and 10 minutes, between 10 and 20 minutes, between 10 and 15 minutes, or between 15 and 20 minutes.

In some embodiments, further growth phases comprising further additions of precursor—a solution comprising a zinc source and a selenium source—are added to the reaction mixture followed by maintaining at an elevated temperature. Typically, additional precursor is provided after reaction of the previous layer is substantially complete (e.g., when at least one of the previous precursors is depleted or removed from the reaction or when no additional growth is detectable). The further additions of precursor create additional layers.

To prevent precipitation of the ZnSe cores as additional layers are added, additional ligand is added during the growth phases. If too much ligand is added during the initial nucleation phase, the concentration of the zinc source and selenium source would be too low and would prevent effective nucleation. Therefore, the ligand is added slowly throughout the additional growth phases. In some embodiments, the additional ligand is oleylamine.

After the ZnSe cores reach the desired thickness and diameter, they can be cooled. In some embodiments, the ZnSe cores are cooled to room temperature. In some embodiments, an organic solvent is added to dilute the reaction mixture comprising the ZnSe cores.

In some embodiments, the organic solvent is hexane, pentane, toluene, benzene, diethylether, acetone, ethyl acetate, dichloromethane (methylene chloride), chloroform, dimethylformamide, or N-methylpyrrolidinone. In some embodiments, the organic solvent is toluene.

In some embodiments, the ZnSe cores are isolated. In some embodiments, the ZnSe cores are isolated by precipitation of the ZnSe from solvent. In some embodiments, the ZnSe cores are isolated by flocculation with ethanol.

The number of layers will determine the size of the ZnSe core. The size of the ZnSe cores can be determined using techniques known to those of skill in the art. In some embodiments, the size of the ZnSe cores is determined using transmission electron microscopy. In some embodiments, the ZnSe cores have an average diameter of between 1 nm and 15 nm, between 1 nm and 10 nm, between 1 nm and 9 nm, between 1 nm and 8 nm, between 1 nm and 7 nm, between 1 nm and 6 nm, between 1 nm and 5 nm, between 5 nm and 15 nm, between 5 nm and 10 nm, between 5 nm and 9 nm, between 5 nm and 8 nm, between 5 nm and 7 nm, between 5 nm and 6 nm, between 6 nm and 15 nm, between 6 nm and 10 nm, between 6 nm and 9 nm, between 6 nm and 8 nm, between 6 nm and 7 nm, between 7 nm and 15 nm, between 7 nm and 10 nm, between 7 nm and 9 nm, between 7 nm and 8 nm, between 8 nm and 15 nm, between 8 nm and 10 nm, between about 8 nm and 9 nm, between 9 nm and 15 nm, between 9 nm and 10 nm, or between 10 nm and 15 nm. In some embodiments, the ZnSe core has an average diameter of between 6 nm and 7 nm.

In some embodiments, the diameter of the ZnSe cores is determined using quantum confinement. Quantum confinement in zero-dimensional nanocrystallites, such as quantum dots, arises from the spatial confinement of electrons within the crystallite boundary. Quantum confinement can be observed once the diameter of the material is of the same magnitude as the de Broglie wavelength of the wave function. The electronic and optical properties of nanoparticles deviate substantially from those of bulk materials. A particle behaves as if it were free when the confining dimension is large compared to the wavelength of the particle. During this state, the bandgap remains at its original energy due to a continuous energy state. However, as the confining dimension decreases and reaches a certain limit, typically in nanoscale, the energy spectrum becomes discrete. As a result, the bandgap becomes size-dependent. This ultimately results in a blueshift in light emission as the size of the particles decreases.

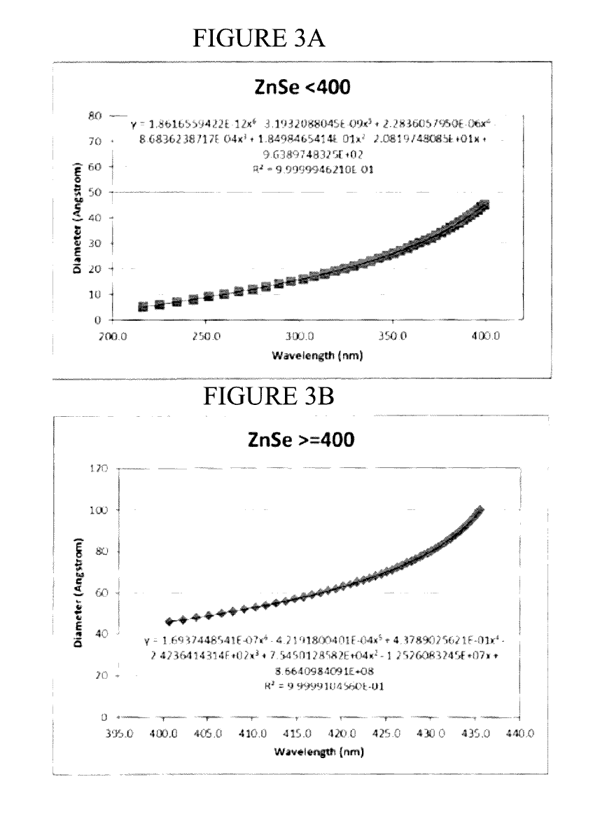

As shown in FIG. 3A and FIG. 3B, the bandgap absorption wavelength versus particle diameter curve was divided into two segments—a segment at a wavelength below 400 nm (3A) and a segment at a wavelength equal to or greater than 400 nm (3B)—and each segment was fitted to a polynomial equation. The resulting polynomial equations were used to calculate the diameter of the ZnSe core (using wavelength as the variable).

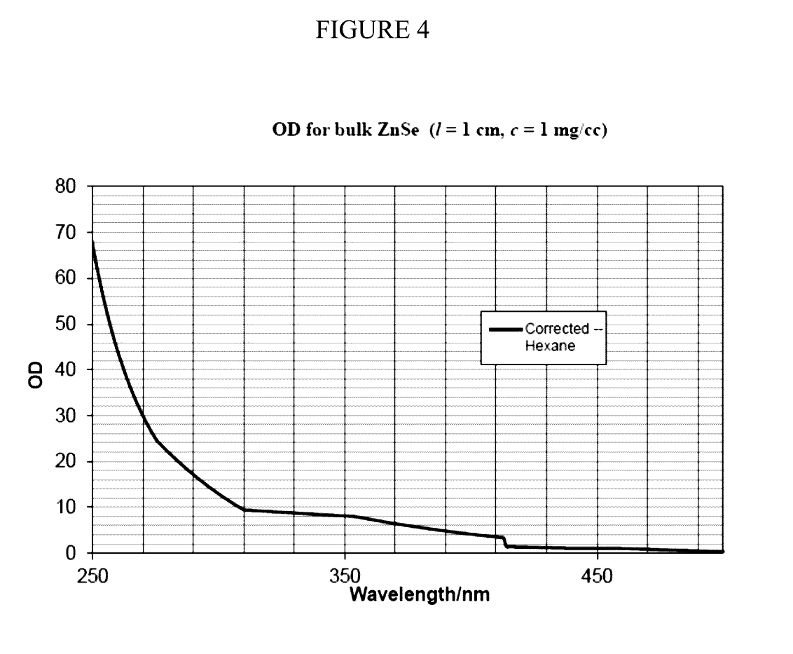

The concentration of the ZnSe cores is also determined in order to calculate the concentration of materials needed to provide a shell layer. The concentration of the ZnSe cores is determined using the absorption coefficient of bulk ZnSe at a low wavelength (e.g., 350 nm). The bulk absorption coefficient of bulk ZnSe is 8.08 mg/mL (using a 1 cm path length and light with a wavelength of 350 nm), as shown in FIG. 4. The concentration can then be calculated using the following equation:

Concentration (mg/mL)=((average optical density (at 350 nm))*(dilution factor))/(8.08)

Wherein, optical density describes the transmission of light through a highly blocking optical filter. Optical density is the negative of the logarithm of the transmission.

In some embodiments, the ZnSe cores of the nanostructures of the present invention have a ZnSe content (by weight) of between 40% to 90%, between 40% and 80%, between 40% and 70%, between 40% and 60%, between 40% and 50%, between 50% to 90%, between 50% and 80%, between 50% and 70%, between 50% and 60%, between 60% to 90%, between 60% and 80%, between 60% and 70%, between 70% to 90%, between 70% and 80%, or between 80% and 90%.

In some embodiments, the ZnSe core nanostructures display a high photoluminescence quantum yield. In some embodiments, the ZnSe core nanostructures display a photoluminescence quantum yield of between 20% to 90%, between 20% and 80%, between 20% and 70%, between 20% and 60%, between 20% and 50%, between 20% and 40%, between 20% and 30%, between 30% to 90%, between 30% and 80%, between 30% and 70%, between 30% and 60%, between 30% and 50%, between 30% and 40%, between 40% to 90%, between 40% and 80%, between 40% and 70%, between 40% and 60%, between 40% and 50%, between 50% to 90%, between 50% and 80%, between 50% and 70%, between 50% and 60%, between 60% to 90%, between 60% and 80%, between 60% and 70%, between 70% to 90%, between 70% and 80%, or between 80% and 90%.

In some embodiments, the ZnSe core nanostructures emit in the blue, indigo, violet, and/or ultraviolet range. In some embodiments, the photoluminescence spectrum for the ZnSe core nanostructures have a emission maximum between 300 nm and 450 nm, between 300 nm and 400 nm, between 300 nm and 350 nm, between 300 nm and 330 nm, between 330 nm and 450 nm, between 330 nm and 400 nm, between 330 nm and 350 nm, between 350 nm and 450 nm, between 350 nm and 400 nm, or between 400 nm and 450 nm. In some embodiments, the photoluminescence spectrum for the ZnSe core nanostructures has an emission maximum of about 435 nm.

The size distribution of the ZnSe core nanostructures can be relatively narrow. In some embodiments, the photoluminescence spectrum of the population can have a full width at half maximum of between 60 nm and 10 nm, between 60 nm and 20 nm, between 60 nm and 30 nm, between 60 nm and 40 nm, between 40 nm and 10 nm, between 40 nm and 20 nm, between 40 nm and 30 nm, between 30 nm and 10 nm, between 30 nm and 20 nm, or between 20 nm and 10 nm.

### Production of the ZnS Shell

In some embodiments, the highly luminescent nanostructures of the present invention include a core and a shell. The shell can, e.g., increase the quantum yield and/or stability of the nanostructures. In some embodiments, the core and the shell comprise different materials. The core is generally synthesized first, optionally enriched, and then additional precursors from which the shell (or a layer thereof) is produced are provided.

Synthesis of a layered ZnSe/ZnS core/shell in at least two discrete steps provides a greater degree of control over the thickness of the resulting layers. And, synthesis of the core and the shell in different steps also provides greater flexibility, for example, in the ability to employ different solvent and ligand systems in the core and shell synthesis. Multi-step synthesis techniques can thus facilitate production of nanostructures with narrow size distribution (i.e., having a small FWHM) and high quantum yield.

In some embodiments, the present invention provides a method for forming a shell comprising at least two layers, in which one or more precursors are provided and reacted to form a first layer, and then (typically after formation of the first layer is substantially complete) adding one or more precursors to form a second layer.

The ZnS shell passivates defects at the ZnSe particle surface, which leads to an improvement in the quantum yield and to higher device efficiencies. Furthermore, spectral impurities which are caused by defect states may be eliminated by passivation, which increases the color saturation.

In some embodiments, the ZnS shell comprises more than one layer of ZnS. In some embodiments, the number of ZnS layers in the ZnS shell is between 2 and 10, between 2 and 9, between 2 and 8, between 2 and 7, between 2 and 6, between 2 and 5, between 2 and 4, between 2 and 3, between 3 and 10, between 3 and 9, between 3 and 8, between 3 and 7, between 3 and 6, between 3 and 5, between 3 and 4, between 4 and 10, between 4 and 9, between 4 and 8, between 4 and 7, between 4 and 6, between 4 and 5, between 5 and 10, between 5 and 9, between 5 and 8, between 5 and 7, between 5 and 6, between 6 and 10, between 6 and 9, between 6 and 8, between 6 and 7, between 7 and 10, between 7 and 9, between 7 and 8, between 8 and 10, between 8 and 9, or between 9 and 10. In some embodiments, the ZnS shell comprises 3 layers of ZnS.

The thickness of the ZnS shell layers can be controlled by varying the amount of precursor provided. For a given layer, at least one of the precursors is optionally provided in an amount whereby, when a growth reaction is substantially complete, the layer is of a predetermined thickness. If more than one different precursor is provided, either the amount of each precursor can be so limited or one of the precursors can be provided in a limiting amount while the others are provided in excess.

The thickness of each ZnS layer of the ZnS shell can be determined using techniques known to those of skill in the art. In some embodiments, the thickness of each layer is determined by comparing the diameter of the ZnSe/ZnS core/shell before and after the addition of each layer. In some embodiments, the diameter of the ZnSe/ZnS core/shell before and after the addition of each layer is determined by transmission electron microscopy. In some embodiments, each ZnS layer has a thickness of between 0.05 nm and 2 nm, between 0.05 nm and 1 nm, between 0.05 nm and 0.5 nm, between 0.05 nm and 0.3 nm, between 0.05 nm and 0.1 nm, between 0.1 nm and 2 nm, between 0.1 nm and 1 nm, between 0.1 nm and 0.5 nm, between 0.1 nm and 0.3 nm, between 0.3 nm and 2 nm, between 0.3 nm and 1 nm, between 0.3 nm and 0.5 nm, between 0.5 nm and 2 nm, between 0.05 nm and 1 nm, or between 1 nm and 2 nm. In some embodiments, each ZnS layer has an average thickness of about 0.33 nm.

In some embodiments, the present invention provides a method of producing a multi-layered nanostructure comprising:
(a) combining a zinc source and a selenium source to produce a reaction mixture comprising a ZnSe nuclei;
(b) contacting the reaction mixture in (a) with a solution comprising a zinc source and a selenium source;
(c) repeating (b) to provide a multi-layered ZnSe core;
(d) contacting the multi-layered ZnSe core of (c) with a solution comprising a zinc carboxylate source and a sulfur source;
(e) repeating (d) to provide a multi-layered nanostructure.

The thickness of the ZnS shell layers can be conveniently controlled by controlling the amount of precursor provided. For a given layer, at least one of the precursors is optionally provided in an amount whereby, when the growth reaction is substantially complete, the layer is of predetermined thickness. If more than one different precursor is provided, either the amount of each precursor can be so limited or one of the precursors can be provided in limiting amount while the others are provided in excess. Suitable precursor amounts for various resulting desired shell thicknesses can be readily calculated. For example, the ZnSe core can be dispersed in solution after its synthesis and purification, and its concentration can be calculated, e.g., by UV/Vis spectroscopy using the Beer-Lambert law. The extinction coefficient can be obtained from bulk ZnSe. The size of the ZnSe core can be determined, e.g., by excitonic peak of UV/Vis absorption spectrum and physical modeling based on quantum confinement. With the knowledge of particle size, molar quantity, and the desired resulting thickness of shelling material, the amount of precursor can be calculated using the bulk crystal parameters (i.e., the thickness of one layer of shelling material).

In one class of embodiments, providing a first set of one or more precursors and reacting the precursors to produce a first layer of the shell comprises providing the one or more precursors in an amount whereby, when the reaction is substantially complete, the first layer has a thickness of between about 0.3 nm and about 1.0 nm of ZnS. Typically, this thickness is calculated assuming that precursor conversion is 100% efficient. A shell can—but need not—completely cover the underlying material. Without limitation to any particular mechanism and purely for the sake of example, where the first layer of the shell is about 0.5 layer of ZnS thick, the core can be covered with small islands of ZnS or about 50% of the cationic sites and 50% of the anionic sites can be occupied by the shell material. Similarly, in one class of embodiments providing a second set of one or more precursors and reacting the precursors to produce a second layer of the shell comprises providing the one or more precursors in an amount whereby, when the reaction is substantially complete, the second layer is between about 1 and about 4 layers of ZnS thick or between about 0.3 nm and about 1.2 nm thick.

In some embodiments, the zinc carboxylate source is produced by reacting a zinc salt and a carboxylic acid.

In some embodiments, the zinc salt is selected from zinc acetate, zinc fluoride, zinc chloride, zinc bromide, zinc iodide, zinc nitrate, zinc triflate, zinc tosylate, zinc mesylate, zinc oxide, zinc sulfate, zinc acetylacetonate, zinc toluene-3,4-dithiolate, zinc p-toluenesulfonate, zinc diethyldithiocarbamate, zinc dibenzyldithiocarbamate, and mixtures thereof.

In some embodiments, the carboxylic acid is selected from acetic acid, propionic acid, butyric acid, valeric acid, caproic acid, heptanoic acid, caprylic acid, capric acid, undecanoic acid, lauric acid, myristic acid, palmitic acid, stearic acid, behenic acid, acrylic acid, methacrylic acid, but-2-enoic acid, but-3-enoic acid, pent-2-enoic acid, pent-4-enoic acid, hex-2-enoic acid, hex-3-enoic acid, hex-4-enoic acid, hex-5-enoic acid, hept-6-enoic acid, oct-2-enoic acid, dec-2-enoic acid, undec-10-enoic acid, dodec-5-enoic acid, oleic acid, gadoleic acid, erucic acid, linoleic acid, α-linolenic acid, calendic acid, eicosadienoic acid, eicosatrienoic acid, arachidonic acid, stearidonic acid, benzoic acid, para-toluic acid, ortho-toluic acid, meta-toluic acid, hydrocinnamic acid, naphthenic acid, cinnamic acid, para-toluenesulfonic acid, and mixtures thereof.

In some embodiments, the zinc carboxylate is zinc stearate or zinc oleate.

In some embodiments, the sulfur source is selected from elemental sulfur, octanethiol, dodecanethiol, octadecanethiol, tributylphosphine sulfide, cyclohexyl isothiocyanate, α-toluenethiol, ethylene trithiocarbonate, allyl mercaptan, bis(trimethylsilyl) sulfide, trioctylphosphine sulfide, and mixtures thereof. In some embodiments, the sulfur source is elemental sulfur.

In some embodiments, the shell layers are synthesized in the presence of at least one nanostructure ligand. Ligands can, e.g., enhance the miscibility of nanostructures in solvents or polymers (allowing the nanostructures to be distributed throughout a composition such that the nanostructures do not aggregate together), increase quantum yield of nanostructures, and/or preserve nanostructure luminescence (e.g., when the nanostructures are incorporated into a matrix). In some embodiments, the ligand(s) for the core synthesis and for the shell synthesis are the same. In some embodiments, the ligand(s) for the core synthesis and for the shell synthesis are different. Following synthesis, any ligand on the surface of the nanostructures can be exchanged for a different ligand with other desirable properties.

In some embodiments, ligands suitable for the synthesis of nanostructure shells, including ZnS shells, are known by those of skill in the art. In some embodiments, the ligand is a fatty acid selected from lauric acid, caproic acid, myristic acid, palmitic acid, stearic acid, and oleic acid. In some embodiments, the ligand is an organic phosphine or an organic phosphine oxide selected from trioctylphosphine oxide (TOPO), trioctylphosphine (TOP), diphenylphosphine (DPP), triphenylphosphine oxide, and tributylphosphine oxide. In some embodiments, the ligand is an amine selected from dodecylamine, oleylamine, hexadecylamine, and octadecylamine. In some embodiments, the ligand is trioctylphosphine (TOP). In some embodiments, the ligand is trioctylphosphine oxide.

In some embodiments, the shell is produced in the presence of a mixture of ligands. In some embodiments, the shell is produced in the presence of a mixture comprising 2, 3, 4, 5, or 6 different ligands. In some embodiments, the shell is produced in the presence of a mixture comprising 2 different ligands. In some embodiments, the mixture of ligands comprises trioctylphosphine and trioctylphosphine oxide. Examples of ligand are disclosed in US Patent Application Publication Nos. 2005/0205849, 2008/0105855, 2008/0118755, 2009/0065764, 2010/0140551, 2013/0345458, 2014/0151600, 2014/0264189, and 2014/0001405.

In some embodiments, in the shell phase, the ZnSe core, sulfur source, and zinc carboxylate source are combined at a reaction temperature between 250° C. and 350° C., between 250° C. and 320° C., between 250° C. and 300° C., between 250° C. and 290° C., between 250° C. and 280° C., between 250° C. and 270° C., between 270° C. and 350° C., between 270° C. and 320° C., between 270° C. and 300° C., between 270° C. and 290° C., between 270° C. and 280° C., between 280° C. and 350° C., between 280° C. and 320° C., between 280° C. and 300° C., between 280° C. and 290° C., between 290° C. and 350° C., between 290° C. and 320° C., between 290° C. and 300° C., 300° C. and 350° C., between 300° C. and 320° C., or between 320° C. and 350° C. In some embodiments, ZnSe core, sulfur source, and zinc carboxylate source are combined at a reaction temperature of about 300° C.

In some embodiments, the reaction mixture—after combining the ZnSe core, sulfur source, and zinc carboxylate source—is maintained at an elevated temperature for between 2 and 20 minutes, between 2 and 15 minutes, between 2 and 10 minutes, between 2 and 8 minutes, between 2 and 5 minutes, between 5 and 20 minutes, between 5 and 15 minutes, between 5 and 10 minutes, between 5 and 8 minutes, between 8 and 20 minutes, between 8 and 15 minutes, between 8 and 10 minutes, between 10 and 20 minutes, between 10 and 15 minutes, or between 15 and 20 minutes.

In some embodiments, further additions of precursor are added to the reaction mixture followed by maintaining at an elevated temperature. Typically, additional precursor is provided after reaction of the previous layer is substantially complete (e.g., when at least one of the previous precursors is depleted or removed from the reaction or when no additional growth is detectable). In some additions the additional precursor added is a sulfur source. The further additions of precursor create additional layers.

After the ZnSe/ZnS core/shell nanostructures reach the desired thickness and diameter, they can be cooled. In some embodiments, the ZnSe/ZnS core/shell nanostructures are cooled to room temperature. In some embodiments, an organic solvent is added to dilute the reaction mixture comprising the ZnSe/ZnS core/shell nanostructures.

In some embodiments, the organic solvent is hexane, pentane, toluene, benzene, diethylether, acetone, ethyl acetate, dichloromethane (methylene chloride), chloroform, dimethylformamide, methanol, ethanol, or N-methylpyrrolidinone. In some embodiments, the organic solvent is toluene.

In some embodiments, the ZnSe/ZnS core/shell nanostructures are isolated. In some embodiments, the ZnSe/ZnS core/shell nanostructures are isolated by precipitation of the ZnSe/ZnS core/shell nanostructures using an organic solvent. In some embodiments, the ZnSe/ZnS core/shell nanostructures are isolated by precipitation with ethanol.

The number of layers will determine the thickness and the diameter of the ZnSe/ZnS core/shell nanostructure. The size of the ZnSe/ZnS core/shell nanostructure can be determined using techniques known to those of skill in the art. In some embodiments, the size of the ZnSe/ZnS core/shell nanostructure is determined using transmission electron microscopy. In some embodiments, the ZnSe/ZnS core/shell nanostructures have an average diameter of between 1 nm and 15 nm, between 1 nm and 10 nm, between 1 nm and 9 nm, between 1 nm and 8 nm, between 1 nm and 7 nm, between 1 nm and 6 nm, between 1 nm and 5 nm, between 5 nm and 15 nm, between 5 nm and 10 nm, between 5 nm and 9 nm, between 5 nm and 8 nm, between 5 nm and 7 nm, between 5 nm and 6 nm, between 6 nm and 15 nm, between 6 nm and 10 nm, between 6 nm and 9 nm, between 6 nm and 8 nm, between 6 nm and 7 nm, between 7 nm and 15 nm, between 7 nm and 10 nm, between 7 nm and 9 nm, between 7 nm and 8 nm, between 8 nm and 15 nm, between 8 nm and 10 nm, between about 8 nm and 9 nm, between 9 nm and 15 nm, between 9 nm and 10 nm, or between 10 nm and 15 nm. In some embodiments, the ZnSe/ZnS core/shell nanostructure has an average diameter of about 7.6 nm.

In some embodiments, the diameter of the ZnSe/ZnS core/shell nanostructures are determined using quantum confinement.

In some embodiments, the ZnSe/ZnS core/shell nanostructures display a high photoluminescence quantum yield. In some embodiments, the ZnSe/ZnS core/shell nanostructures display a photoluminescence quantum yield of between 60% to 99%, between 60% and 95%, between 60% and 90%, between 60% and 85%, between 60% and 80%, between 60% and 70%, between 70% and 99%, between 70% and 95%, between 70% to 90%, between 70% and 85%, between 70% and 80%, between 80% and 99%, between 80% and 95%, between 80% and 90%, between 80% to 85%, between 85% and 99%, between 85% and 95%, between 85% and 90%, between 90% and 99%, between 90% to 95%, or between 95% and 99%. In some embodiments, the ZnSe/ZnS core/shell nanostructures display a photoluminescence quantum yield between 85% and 96%.

The photoluminescence spectrum of the ZnSe/ZnS core/shell nanostructures can cover the ultraviolet A to blue portion of the spectrum. For example, the nanostructures can emit in the blue, indigo, violet, and/or ultraviolet range. In some embodiments, the photoluminescence spectrum for the ZnSe/ZnS core/shell nanostructures have a emission maximum between 300 nm and 450 nm, between 300 nm and 400 nm, between 300 nm and 350 nm, between 300 nm and 330 nm, between 330 nm and 450 nm, between 330 nm and 400 nm, between 330 nm and 350 nm, between 350 nm and 450 nm, between 350 nm and 400 nm, or between 400 nm and 450 nm. In some embodiments, the photoluminescence spectrum for the ZnSe/ZnS core/shell nanostructures has an emission maximum of between 430 nm and 440 nm. In some embodiments, the photoluminescence spectrum for the ZnSe/ZnS core/shell nanostructures has an emission maximum of about 435 nm.

The size distribution of the ZnSe/ZnS core/shell nanostructures can be relatively narrow. In some embodiments, the photoluminescence spectrum of the ZnSe/ZnS core/shell nanostructure population can have a full width at half maximum of between 60 nm and 10 nm, between 60 nm and 20 nm, between 60 nm and 30 nm, between 60 nm and 40 nm, between 40 nm and 10 nm, between 40 nm and 20 nm, between 40 nm and 30 nm, between 30 nm and 10 nm, between 30 nm and 20 nm, or between 20 nm and 10 nm. In some embodiments, the ZnSe/ZnS core/shell nanostructure population can have a FWHM of between 20 nm and 25 nm.

### ZnSe/ZnS Core/Shell Nanostructures

The resulting core/shell nanostructures are optionally embedded in a matrix (e.g., an organic polymer, silicon-containing polymer, inorganic, glassy, and/or other matrix), used in production of a nanostructure phosphor, and/or incorporated into a device, e.g., an LED, backlight, downlight, or other display or lighting unit or an optical filter. Exemplary phosphors and lighting units can, e.g., generate a specific color light by incorporating a population of nanostructures with an emission maximum at or near the desired wavelength or a wide color gamut by incorporating two or more different populations of nanostructures having different emission maxima. A variety of suitable matrices are known in the art. See, e.g., U.S. Pat. No. 7,068,898 and US patent application publications 2010/0276638, 2007/0034833, and 2012/0113672. Exemplary nanostructure phosphor films, LEDs, backlighting units, etc. are described, e.g., in US Patent Application Publications Nos. 2010/0276638, 2012/0113672, 2008/0237540, 2010/0110728, and 2010/0155749 and U.S. Pat. Nos. 7,374,807, 7,645,397, 6,501,091, and 6,803,719.

As another example, the resulting core/shell nanostructures can be used for imaging or labeling, e.g., biological imaging or labeling. Thus, the resulting core/shell nanostructures are optionally covalently or noncovalently bound to biomolecule(s), including, but not limited to, a peptide or protein (e.g., an antibody or antibody domain, avidin, streptavidin, neutravidin, or other binding or recognition molecule), a ligand (e.g., biotin), a polynucleotide (e.g., a short oligonucleotide or longer nucleic acid), a carbohydrate, or a lipid (e.g., a phospholipid or other micelle). One or more core/shell nanostructures can be bound to each biomolecule, as desired for a given application. Such core/shell nanostructure-labeled biomolecules find use, for example, in vitro, in vivo, and in cellulo, e.g., in exploration of binding or chemical reactions as well as in subcellular, cellular, and organismal labeling.

Core/shell nanostructures resulting from the methods are also a feature of the invention. Thus, one class of embodiments provides a population of ZnSe/ZnS core/shell nanostructures or nanostructures comprising ZnSe cores in which the nanostructures or cores have an Zn: Se ratio of essentially 1:1 (e.g., greater than 0.99:1). The nanostructures are optionally quantum dots.

Production of a ZnSeₓS₁₋ₓ Buffer Layer

In some embodiments, the highly luminescent nanostructures include a buffer layer between the core and the shell. In some embodiments, the nanostructure is a ZnSe/ZnSeₓS₁₋ₓ/ZnS core/buffer layer/shell quantum dot, wherein 0<x<1.

In some embodiments, the nanostructure comprises a ZnSeₓS₁₋ₓ buffer layer, wherein 0<x<1, 0.25<x<1, 0.5<x<1, 0.75<x<1, 0.25<x<0.75, 0.25<x<0.5, 0.5<x<1, 0.5<x<0.75, or 0.75<x<1.

In some embodiments, the ZnSeₓS₁₋ₓ buffer layer eases the lattice strain between the ZnSe core and the ZnS shell.

In some embodiments, the ZnSeₓS₁₋ₓ buffer layer comprises one layer of ZnSeₓS₁₋ₓ. In some embodiments, the ZnSeₓS₁₋ₓ buffer layer comprises more than one layer of ZnSeₓS₁₋ₓ. In some embodiments, the number of ZnSeₓS₁₋ₓ layers in the ZnSeₓS₁₋ₓ buffer layer is between 2 and 10, between 2 and 9, between 2 and 8, between 2 and 7, between 2 and 6, between 2 and 5, between 2 and 4, between 2 and 3, between 3 and 10, between 3 and 9, between 3 and 8, between 3 and 7, between 3 and 6, between 3 and 5, between 3 and 4, between 4 and 10, between 4 and 9, between 4 and 8, between 4 and 7, between 4 and 6, between 4 and 5, between 5 and 10, between 5 and 9, between 5 and 8, between 5 and 7, between 5 and 6, between 6 and 10, between 6 and 9, between 6 and 8, between 6 and 7, between 7 and 10, between 7 and 9, between 7 and 8, between 8 and 10, between 8 and 9, or between 9 and 10.

The thickness of the ZnSeₓS₁₋ₓ buffer layer can be controlled by varying the amount of precursor provided. For a given layer, at least one of the precursors is optionally provided in an amount whereby, when a growth reaction is substantially complete, the layer is of a predetermined thickness. If more than one different precursor is provided, either the amount of each precursor can be so limited or one of the precursors can be provided in a limiting amount while the others are provided in excess.

The thickness of each ZnSeₓS₁₋ₓ layer of the ZnSeₓS₁₋ₓ buffer layer can be determined using techniques known to those of skill in the art. The thickness of each layer is determined by comparing the diameter of the ZnSe/ZnSeₓS₁₋ₓ core/buffer layer before and after the addition of each layer. In some embodiments, the diameter of the ZnSe/ZnSeₓS₁₋ₓ core/buffer layer before and after the addition of each layer is determined by transmission electron microscopy. In some embodiments, each ZnSeₓS₁₋ₓ layer has a thickness of between 0.05 nm and 2 nm, between 0.05 nm and 1 nm, between 0.05 nm and 0.5 nm, between 0.05 nm and 0.3 nm, between 0.05 nm and 0.1 nm, between 0.1 nm and 2 nm, between 0.1 nm and 1 nm, between 0.1 nm and 0.5 nm, between 0.1 nm and 0.3 nm, between 0.3 nm and 2 nm, between 0.3 nm and 1 nm, between 0.3 nm and 0.5 nm, between 0.5 nm and 2 nm, between 0.05 nm and 1 nm, or between 1 nm and 2 nm. In some embodiments, each ZnSeₓS₁₋ₓ layer has an average thickness of about 0.33 nm.

In some embodiments, the present invention provides a method of producing a multi-layered nanostructure comprising:
(a) combining a zinc source and a selenium source to produce a reaction mixture comprising a ZnSe nuclei;
(b) contacting the reaction mixture in (a) with a solution comprising a zinc source and a selenium source;
(c) repeating (b) to provide a multi-layered ZnSe core;
(d) contacting the multi-layered ZnSe core of (c) with a solution comprising a zinc source, a selenium source, and a sulfur source;
(e) repeating (d) to provide a multi-layered ZnSe/ZnSeₓS₁₋ₓ core/buffer layer;
(f) contacting the multi-layered ZnSe/ZnSeₓS₁₋ₓ core/buffer layer of (e) with a solution comprising a zinc carboxylate source and a sulfur source;
(g) repeating (f) to provide a multi-layered nanostructure.

The thickness of the ZnSeₓS₁₋ₓ buffer layer can be conveniently controlled by controlling the amount of precursor provided. For a given layer, at least one of the precursors is optionally provided in an amount whereby, when the growth reaction is substantially complete, the layer is of predetermined thickness. If more than one different precursor is provided, either the amount of each precursor can be so limited or one of the precursors can be provided in limiting amount while the others are provided in excess. Suitable precursor amounts for various resulting desired shell thicknesses can be readily calculated. For example, the ZnSe/ZnSeₓS₁₋ₓ core/buffer layer can be dispersed in solution after its synthesis and purification, and its concentration can be calculated, e.g., by UV/Vis spectroscopy using the Beer-Lambert law. The extinction coefficient can be obtained from bulk ZnSe and bulk ZnSeₓS₁₋ₓ. The size of the ZnSe/ZnSeₓS₁₋ₓ core/buffer layer can be determined, e.g., by excitonic peak of UV/Vis absorption spectrum and physical modeling based on quantum confinement. With the knowledge of particle size, molar quantity, and the desired resulting thickness of shelling material, the amount of precursor can be calculated using the bulk crystal parameters (i.e., the thickness of one layer of shelling material).

In one class of embodiments, providing a first set of one or more precursors and reacting the precursors to produce a first layer of the shell comprises providing the one or more precursors in an amount whereby, when the reaction is substantially complete, the first layer has a thickness of between about 0.3 nm and about 1.0 nm of ZnSeₓS₁₋ₓ. Typically, this thickness is calculated assuming that precursor conversion is 100% efficient. A shell can—but need not—completely cover the underlying material. Without limitation to any particular mechanism and purely for the sake of example, where the first layer of the buffer layer is about 0.5 layer of ZnSeₓS₁₋ₓ thick, the core can be covered with small islands of ZnSeₓS₁₋ₓ or about 50% of the cationic sites and 50% of the anionic sites can be occupied by the shell material. Similarly, in one class of embodiments providing a second set of one or more precursors and reacting the precursors to produce a second layer of the shell comprises providing the one or more precursors in an amount whereby, when the reaction is substantially complete, the second layer is between about 1 and about 4 layers of ZnSeₓS₁₋ₓ thick or between about 0.3 nm and about 1.2 nm thick.

In some embodiments, the zinc source is a dialkyl zinc compound. In some embodiments, the zinc source is diethylzinc, dimethylzinc, zinc acetate, zinc acetylacetonate, zinc iodide, zinc bromide, zinc chloride, zinc fluoride, zinc carbonate, zinc cyanide, zinc nitrate, zinc oxide, zinc peroxide, zinc perchlorate, or zinc sulfate. In some embodiments, the zinc source is diethylzinc or dimethylzinc. In some embodiments, the zinc source is diethylzinc.

In some embodiments, the selenium source is selected from trioctylphosphine selenide, tri(n-butyl)phosphine selenide, tri(sec-butyl)phosphine selenide, tri(tert-butyl)phosphine selenide, trimethylphosphine selenide, triphenylphosphine selenide, diphenylphosphine selenide, phenylphosphine selenide, cyclohexylphosphine selenide, octaselenol, dodecaselenol, selenophenol, elemental selenium, hydrogen selenide, bis(trimethylsilyl) selenide, and mixtures thereof. In some embodiments, the selenium source is elemental selenium.

In some embodiments, the sulfur source is selected from elemental sulfur, octanethiol, dodecanethiol, octadecanethiol, tributylphosphine sulfide, cyclohexyl isothiocyanate, α-toluenethiol, ethylene trithiocarbonate, allyl mercaptan, bis(trimethylsilyl) sulfide, trioctylphosphine sulfide, and mixtures thereof. In some embodiments, the sulfur source is elemental sulfur.

In some embodiments, the buffer layers are synthesized in the presence of at least one nanostructure ligand. Ligands can, e.g., enhance the miscibility of nanostructures in solvents or polymers (allowing the nanostructures to be distributed throughout a composition such that the nanostructures do not aggregate together), increase quantum yield of nanostructures, and/or preserve nanostructure luminescence (e.g., when the nanostructures are incorporated into a matrix). In some embodiments, the ligand(s) for the core synthesis and for the buffer synthesis are the same. In some embodiments, the ligand(s) for the core synthesis and for the buffer layer synthesis are different. Following synthesis, any ligand on the surface of the nanostructures can be exchanged for a different ligand with other desirable properties.

In some embodiments, ligands suitable for the synthesis of nanostructure buffer layers, including ZnSeₓS₁₋ₓ buffer layers, are known by those of skill in the art. In some embodiments, the ligand is a fatty acid selected from lauric acid, caproic acid, myristic acid, palmitic acid, stearic acid, and oleic acid. In some embodiments, the ligand is an organic phosphine or an organic phosphine oxide selected from trioctylphosphine oxide (TOPO), trioctylphosphine (TOP), diphenylphosphine (DPP), triphenylphosphine oxide, and tributylphosphine oxide. In some embodiments, the ligand is an amine selected from dodecylamine, oleylamine, hexadecylamine, and octadecylamine. In some embodiments, the ligand is trioctylphosphine (TOP). In some embodiments, the ligand is trioctylphosphine oxide.

In some embodiments, the buffer layer is produced in the presence of a mixture of ligands. In some embodiments, the buffer layer is produced in the presence of a mixture comprising 2, 3, 4, 5, or 6 different ligands. In some embodiments, the buffer layer is produced in the presence of a mixture comprising 2 different ligands. In some embodiments, the mixture of ligands comprises trioctylphosphine and trioctylphosphine oxide. Examples of ligand are disclosed in US Patent Application Publication Nos. 2005/0205849, 2008/0105855, 2008/0118755, 2009/0065764, 2010/0140551, 2013/0345458, 2014/0151600, 2014/0264189, and 2014/0001405.

In some embodiments, in the buffer layer phase, the ZnSe core, zinc source, selenium source, and sulfur source are combined at a reaction temperature between 250° C. and 350° C., between 250° C. and 320° C., between 250° C. and 300° C., between 250° C. and 290° C., between 250° C. and 280° C., between 250° C. and 270° C., between 270° C. and 350° C., between 270° C. and 320° C., between 270° C. and 300° C., between 270° C. and 290° C., between 270° C. and 280° C., between 280° C. and 350° C., between 280° C. and 320° C., between 280° C. and 300° C., between 280° C. and 290° C., between 290° C. and 350° C., between 290° C. and 320° C., between 290° C. and 300° C., 300° C. and 350° C., between 300° C. and 320° C., or between 320° C. and 350° C. In some embodiments, ZnSe core, zinc source, selenium source, and sulfur source are combined at a reaction temperature of about 300° C.

In some embodiments, the reaction mixture—after combining the ZnSe core, zinc source, selenium source, and sulfur source—is maintained at an elevated temperature for between 2 and 20 minutes, between 2 and 15 minutes, between 2 and 10 minutes, between 2 and 8 minutes, between 2 and 5 minutes, between 5 and 20 minutes, between 5 and 15 minutes, between 5 and 10 minutes, between 5 and 8 minutes, between 8 and 20 minutes, between 8 and 15 minutes, between 8 and 10 minutes, between 10 and 20 minutes, between 10 and 15 minutes, or between 15 and 20 minutes.

In some embodiments, further additions of precursor are added to the reaction mixture followed by maintaining at an elevated temperature. Typically, additional precursor is provided after reaction of the previous layer is substantially complete (e.g., when at least one of the previous precursors is depleted or removed from the reaction or when no additional growth is detectable). In some additions the additional precursor added is a sulfur source. The further additions of precursor create additional layers.

After the ZnSe/ZnSeₓS₁₋ₓ core/buffer layer nanostructures reach the desired thickness and diameter, they can be cooled. In some embodiments, the ZnSe/ZnSeₓS₁₋ₓ core/buffer layer nanostructures are cooled to room temperature. In some embodiments, an organic solvent is added to dilute the reaction mixture comprising the ZnSe/ZnSeₓS₁₋ₓ core/buffer layer nanostructures.

In some embodiments, the organic solvent is hexane, pentane, toluene, benzene, diethylether, acetone, ethyl acetate, dichloromethane (methylene chloride), chloroform, dimethylformamide, methanol, ethanol, or N-methylpyrrolidinone. In some embodiments, the organic solvent is toluene.

In some embodiments, the ZnSe/ZnSeₓS₁₋ₓ core/buffer layer nanostructures are isolated. In some embodiments, the ZnSe/ZnSeₓS₁₋ₓ core/buffer layer nanostructures are isolated by precipitation of the ZnSe/ZnSeₓS₁₋ₓ core/buffer layer nanostructures using an organic solvent. In some embodiments, the ZnSe/ZnSeₓS₁₋ₓ core/buffer layer nanostructures are isolated by precipitation with ethanol.

The number of layers will determine the size of the ZnSe/ZnSeₓS₁₋ₓ core/buffer layer nanostructure. The size of the ZnSe/ZnSeₓS₁₋ₓ core/buffer layer nanostructure can be determined using techniques known to those of skill in the art. In some embodiments, the size of the ZnSe/ZnSeₓS₁₋ₓ core/buffer layer nanostructure is determined using transmission electron microscopy. In some embodiments, the ZnSe/ZnSeₓS₁₋ₓ core/buffer layer nanostructures have an average diameter of between 1 nm and 15 nm, between 1 nm and 10 nm, between 1 nm and 9 nm, between 1 nm and 8 nm, between 1 nm and 7 nm, between 1 nm and 6 nm, between 1 nm and 5 nm, between 5 nm and 15 nm, between 5 nm and 10 nm, between 5 nm and 9 nm, between 5 nm and 8 nm, between 5 nm and 7 nm, between 5 nm and 6 nm, between 6 nm and 15 nm, between 6 nm and 10 nm, between 6 nm and 9 nm, between 6 nm and 8 nm, between 6 nm and 7 nm, between 7 nm and 15 nm, between 7 nm and 10 nm, between 7 nm and 9 nm, between 7 nm and 8 nm, between 8 nm and 15 nm, between 8 nm and 10 nm, between about 8 nm and 9 nm, between 9 nm and 15 nm, between 9 nm and 10 nm, or between 10 nm and 15 nm. In some embodiments, the ZnSe/ZnS core/buffer layer nanostructure has an average diameter of about 7.6 nm.

In some embodiments, the diameter of the ZnSe/ZnSeₓS₁₋ₓ core/buffer layer nanostructures are determined using quantum confinement.

ZnSe/ZnSeₓS₁₋ₓ/ZnS Core/Buffer Layer/Shell Nanostructures

The resulting core/buffer layer/shell nanostructures are optionally embedded in a matrix (e.g., an organic polymer, silicon-containing polymer, inorganic, glassy, and/or other matrix), used in production of a nanostructure phosphor, and/or incorporated into a device, e.g., an LED, backlight, downlight, or other display or lighting unit or an optical filter. Exemplary phosphors and lighting units can, e.g., generate a specific color light by incorporating a population of nanostructures with an emission maximum at or near the desired wavelength or a wide color gamut by incorporating two or more different populations of nanostructures having different emission maxima. A variety of suitable matrices are known in the art. See, e.g., U.S. Pat. No. 7,068,898 and US patent application publications 2010/0276638, 2007/0034833, and 2012/0113672. Exemplary nanostructure phosphor films, LEDs, backlighting units, etc. are described, e.g., in US Patent Application Publications Nos. 2010/0276638, 2012/0113672, 2008/0237540, 2010/0110728, and 2010/0155749 and U.S. Pat. Nos. 7,374,807, 7,645,397, 6,501,091, and 6,803,719.

As another example, the resulting core/buffer layer/shell nanostructures can be used for imaging or labeling, e.g., biological imaging or labeling. Thus, the resulting core/buffer layer/shell nanostructures are optionally covalently or noncovalently bound to biomolecule(s), including, but not limited to, a peptide or protein (e.g., an antibody or antibody domain, avidin, streptavidin, neutravidin, or other binding or recognition molecule), a ligand (e.g., biotin), a polynucleotide (e.g., a short oligonucleotide or longer nucleic acid), a carbohydrate, or a lipid (e.g., a phospholipid or other micelle). One or more core/buffer layer/shell nanostructures can be bound to each biomolecule, as desired for a given application. Such core/buffer layer/shell nanostructure-labeled biomolecules find use, for example, in vitro, in vivo, and in cellulo, e.g., in exploration of binding or chemical reactions as well as in subcellular, cellular, and organismal labeling.

Core/buffer layer/shell nanostructures resulting from the methods are also a feature of the invention. Thus, one class of embodiments provides a population of ZnSe/ZnSeₓS₁₋ₓ/ZnS core/buffer layer/shell nanostructures or nanostructures comprising ZnSe cores in which the nanostructures or cores have an Zn: Se ratio of essentially 1:1 (e.g., greater than 0.99:1). The nanostructures are optionally quantum dots.

The following examples are illustrative and non-limiting, of the products and methods described herein. Suitable modifications and adaptations of the variety of conditions, formulations, and other parameters normally encountered in the field and which are obvious to those skilled in the art in view of this disclosure are within the spirit and scope of the invention.

### EXAMPLES

The following sets forth a series of experiments that demonstrate growth of highly luminescent nanostructures, including synthesis of a ZnSe/ZnS core/shell.

### Example 1

### Synthesis of ZnSe Nanostructures

For preparation of 9.82 g of ZnSe core (assuming 100% production yield):

Chemicals used:
Diethylzinc (ZnEt₂);
Selenium (Se);
Trioctylphosphine (TOP);
Diphenylphosphine (DPP);
Oleylamine (OYA);
Toluene;
Ethanol (EtOH); and
Hexanes.

Measure out 15 mL of OYA into a 250 mL 3-neck flask along with a stir bar. Equip the flask with an air-free adaptor on a Schlenk line. Use rubber septa to close the two side-necks of the flask. Evacuate the flask and then purge it with nitrogen. Repeat this step 3 times. Heat the solution to 110° C. and maintain at this temperature for 30 minutes under evacuation.

Prepare a syringe containing the following chemicals in the glovebox:
DPP/TOP (45% DPP by weight)—500 μL;
TOP—1 mL; and

HSe—1.5 mL (1.92 M solution of Se dissolved in TOP).

Prepare an injection solution containing the following chemicals in the glovebox:
TOP—2.5 mL; and
ZnEt₂ —295 μL.

Prepare a stock solution containing the following chemicals in the glovebox:
TOP—29.5 mL;
HSe—51.0 mL (1.92 M solution of Se dissolved in TOP); and
ZnEt₂ —6.7 mL.
   Place the stock solution in two 50 mL syringes and place bent metal needles on them to allow for slow addition into the flask using a syringe pump.

Prepare two oleylamine syringes each containing 80 mL of OYA with a bent metal needle to be used with a second syringe pump.

For the nucleation phase: Put the flask back on nitrogen flow and set the temperature to 300° C. When the temperature of the growth solution in the flask is close to 300° C., inject the syringe containing the Se precursor. Once the temperature climbs back up to nearly 300° C., stop the heating and set the controller to 280° C. When the temperature is 300° C., start a timer and inject the Zn solution swiftly. The flask should be cooled with the air gun to a temperature of 280° C. and this temperature should be maintained for the growth process.

For the growth phase: After 5 minutes have elapsed after the initial injection, the pumping of the stock solution should begin. The syringe pump should be programmed to pump in enough precursors to cover all of the nuclei formed in the initial injection with 1 layer of ZnSe and then stop. The pumping then stops for several minutes and the particles are allowed to grow and anneal. After the several minute hold additional precursor will be pumped in to grow another layer, followed by another several minute hold. This process continues until the particles have reached the desired size. In this case, 7 layers were added. An excel spreadsheet was used to calculate the desired amount of precursor needed for each layer based on the surface area of an average particle and the total number of particles. This information is based on data from previous reactions.

Addition of oleylamine: Throughout the growth phase, additional OYA is added to the flask. Starting after the addition of the 2nd layer of ZnSe precursors, OYA is added during each hold period in between the addition of ZnSe layers. If no OYA were added, the dots would precipitate out as they grew larger. If all of the OYA were in the flask during the initial injection step, the precursor concentration would be too low to allow for effective nucleation. For this reason the OYA needs to be added slowly throughout the course of the reaction.

After cooling down, the flask was transferred to the glovebox under the protection of N₂.

Move the product to a 500 mL jar and dilute with toluene.

Isolation of the nanostructures: the original solution from the synthesis is diluted with an equal volume of toluene, and the nanostructures are precipitated by adding ethanol (volume of ethanol is equal to the diluted nanostructure solution). By centrifugation the dots are separated. These separated nanostructures are redispersed in hexane (150 mL).

Transfer into TOP: The solution of nanostructures in hexane is then transferred into a Schlenk flask and 150 mL of TOP is added. The hexane is then removed under vacuum, leaving the nanostructures dispersed in TOP.

Core concentration measurement: A small amount of the core solution is then diluted in hexane and its absorption spectrum is measured. Based on the absorption of the diluted solution at 350 nm, the concentration of the original solution is calculated.

For preparation of the ZnSe/ZnS core/shell nanostructures:

The reaction produced 415 mg of nanostructures (based on 100% yield). A 3 layer ZnS shell was grown on each particle. 5 mL of the core-TOP was used (concentration=55.68 mg/mL, λ_{abs}=419 nm).

Materials and Chemicals:
ZnSe nanostructures as synthesized (absorption peak at 419 nm), isolated from the original reaction solution and transferred into TOP;
Zinc stearate (ZnSt₂);
Sulfur (S);
Lauric acid (LA);
Trioctylphosphine oxide (TOPO);
Trioctylphoshine (TOP)
1-Octadecene (ODE);
Toluene; and
Ethanol (EtOH).

Connect a 100 ml 3-neck flask the Schlenk line with an air-free adaptor. Close the other two necks with rubber septa. Weigh out the following chemicals into the flask along with a stir bar:
ZnSt₂ —1.724 g;
LA—2.185 g; and
TOPO—7.733 g.

In the glove box, prepare the following syringes and add them to the flask in air:
TOP—15.5 mL; and
ODE—4.2 mL.

Evacuate the flask and refill with N₂. Repeat this cycle two more times.

Set the temperature controller to 250° C. and turn the stirring on. As the solution heats up the ZnSt₂ will become fully dissolved. Once the temperature reaches 250° C. turn the heating off and cool the flask with CDA down to a temperature of 110° C. The solution should remain clear and colorless. Once the flask has cooled, switch over to vacuum and evacuate the flask for 30 minutes at 110° C.

While the flask is being degassed the rest of the syringes can be prepared. The sulfur stock solution was previously prepared by dissolving elemental S in TOP to a concentration of 0.2 M. A volume of 13.64 mL is necessary for this reaction. A syringe of the core solution should be prepared with a volume of 5 mL.

After the evacuation is complete the flask should be switched to N₂ and the temperature controller set to 310° C. The core solution should then be injected into the flask and the rate of stirring should be increased. While the temperature is ramping up to the reaction temperature the syringe pump should be set up with the syringe containing the TOP-S stock solution. The syringe pump should be programmed to add the precursor one layer at a time.

Once the temperature reaches 310° C. the precursor addition can begin. The syringe pump should be programmed to pump enough precursor in for the first layer (3.76 mL) at a rate of 0.5 mL/min. After pumping this amount there is a 10 minute hold step that allows the formation and annealing of the first layer. Then enough precursor for the second layer (4.52 mL) is pumped in at the same rate as before, followed by another 10 minute hold step. Finally, enough precursor for the third layer (5.36 mL) is pumped in followed by the last 10 minute hold step. At this point the reaction is finished and the flask can be cooled down.

Once the flask is cool enough to handle it should be pumped into the glove box and diluted with an equal volume of toluene, in this case 50 mL.

The core/shell nanostructures can then be precipitated out of solution by adding an equal volume of ethanol. The precipitate is then collected by centrifugation and the supernatant discarded. The dots can then be redispersed in a non-polar solvent such as hexane or toluene. Further washing cycles can be repeated if desired.

### Quantum Yield Measurement

On the basis of following equation, relative quantum yield of core/shell nanostructures is calculated using fluorescein dye as a reference for green-emitting core/shell nanostructures at the 440 nm excitation wavelength and rhodamine 640 as a reference for red-emitting core/shell nanostructures at the 540 nm excitation wavelength:

$${Φ}_{X} = {Φ}_{ST} ( \frac{{Grad}_{X}}{{Grad}_{ST}} ) ( \frac{{η}_{X}^{2}}{{η}_{ST}^{2}} ) .$$

The subscripts ST and X denote the standard (reference dye) and the core/shell nanostructure solution (test sample), respectively. Φ_{X} is the quantum yield of the core/shell nanostructure, and Φ_{ST} is the quantum yield of the reference dye. Grad=(I/A), I is the area under the emission peak (wavelength scale); A is the absorbance at excitation wavelength. η is the refractive index of dye or core/shell nanostructure in the solvent. See, e.g., Williams et al. (1983) “Relative fluorescence quantum yields using a computer controlled luminescence spectrometer” Analyst 108:1067. The references listed in Williams et al. are for green and red nanocrystals. For ZnSe/ZnS nanocrystals, diphenylanthracene was used as the reference solution with an excitation wavelength of 355 nm.

Representative optical data for blue-emitting quantum dots produced basically as described above are presented in Table 1.

TABLE 1
Representative optical data for blue-emitting
ZnSe/ZnS core/shell nanostructures.

| Sample No. | Emission (nm) | FWHM (nm) | Quantum Yield (%) |
|---|---|---|---|
| 1 | 438 | 24.3 | 89 |
| 2 | 435.7 | 24.5 | 92 |
| 3 | 436.3 | 20.6 | 89.3 |
| 4 | 436.5 | 20.8 | 91.4 |
| 5 | 436.4 | 20.5 | 90.5 |
| 6 | 438.3 | 21.6 | 93.4 |
| 7 | 437.2 | 21.3 | 95.1 |

As shown in Table 1, the present invention provides core/shell nanostructures having a high quantum yield for photoluminescent emission in the blue region of the visible spectrum.

Having now fully described this invention, it will be understood by those of ordinary skill in the art that the same can be performed within a wide and equivalent range of conditions, formulations and other parameters without affecting the scope of the invention or any embodiment thereof. All patents, patent applications, and publications cited herein are fully incorporated by reference herein in their entirety.

1. A nanostructure comprising a core surrounded by a shell, wherein the core comprises two or more layers comprising ZnSe; and the shell comprises two or more layers comprising ZnS.

2. The nanostructure of claim 1, wherein the emission wavelength of the nanostructure is between 400 nm and 460 nm.

3.-4. (canceled)

5. The nanostructure of claim 1, wherein the core comprises between five and eight layers.

6. (canceled)

7. The nanostructure of claim 1, wherein the shell comprises between two and five layers.

8. (canceled)

9. The nanostructure of claim 1, wherein the nanostructure has a particle size between 5 nm and 10 nm.

10. (canceled)

11. The nanostructure of claim 1, wherein the photoluminescence quantum yield is between 80% and 99%.

12. (canceled)

13. The nanostructure of claim 1, wherein the thickness of each layer comprising ZnSe is between 0.2 nm and 0.5 nm.

14. (canceled)

15. The nanostructure of claim 1, wherein the thickness of each layer comprising ZnS is between 0.2 nm and 0.5 nm.

16. (canceled)

17. The nanostructure of claim 1, wherein the nanostructure is a quantum dot.

18. (canceled)

19. The nanostructure of claim 1, wherein the nanostructure is free of cadmium.

20. The nanostructure of claim 1, wherein the nanostructure further comprises one or more layers comprising ZnSeₓS₁₋ₓ, wherein 0<x<1, between the core and the shell.

21.-23. (canceled)

24. A method of producing a multi-layered nanostructure comprising:
(a) combining a zinc source and a selenium source to produce a reaction mixture comprising a ZnSe nucleus;
(b) contacting the reaction mixture obtained in (a) with a solution comprising a zinc source and a selenium source;
(c) repeating (b) to provide a multi-layered nanostructure.

25. The method of claim 24, wherein the zinc source in (a) is a dialkyl zinc.

26. (canceled)

27. The method of claim 24, wherein the selenium source in (a) is hydrogen selenide.

28. The method according to claim 24, wherein in (a) the zinc source, the selenium source, an organic phosphine ligand, and an amine ligand are combined to form the reaction mixture.

29. The method of claim 24, wherein the combining in (a) is at a temperature between 250° C. and 320° C.

30. (canceled)

31. The method of claim 24, wherein the zinc source in (b) is a dialkyl zinc.

32.-33. (canceled)

34. The method of claim 24, wherein the selenium source in (b) is hydrogen selenide.

35. The method of claim 24, wherein the contacting in (b) is at a temperature between 250° C. and 320° C.

36. (canceled)

37. The method of claim 24, wherein the repeating in (c) is between four and eight times.

38. (canceled)

39. The method of claim 24, wherein the contacting in (b) is maintained for between 5 minutes and 15 minutes before the repeating in (c).

40.-46. (canceled)

47. The method of claim 24, wherein the zinc source in (a) and (b) is diethylzinc, the selenium source in (a) and (b) is elemental selenium, the reaction mixture in (a) further comprises the ligands oleylamine, trioctylphosphine, and diphenylphosphine, and wherein the repeating in (c) is five times.

48. A method of producing a multi-layered core/shell nanostructure comprising:
(d) combining the multi-layered nanostructure of claim 24 with a solution comprising a zinc carboxylate source and a sulfur source; and
(e) repeating (d) to provide a multi-layered core/shell nanostructure.

49. The method of claim 48, wherein the zinc carboxylate source of (d) is zinc stearate or zinc oleate.

50. The method of claim 48, wherein the combining in (d) is at a temperature between 250° C. and 320° C.

51. (canceled)

52. The method of claim 48, wherein the sulfur source of (d) is selected from the group consisting of elemental sulfur, octanethiol, and dodecanethiol.

53. (canceled)

54. The method of claim 48, wherein the repeating in (e) is between one and three times.

55. (canceled)

56. The method of claim 48, wherein the contacting in (d) is maintained for between 5 minutes and 15 minutes before the repeating in (e).

57. The method of claim 48, wherein the contacting in (d) further comprises at least one ligand.

58. The method according to claim 57, wherein the at least one ligand is an organic phosphine.

59.-62. (canceled)

63. A method of producing a multi-layered core/buffer layer/shell nanostructure comprising:
(d) combining the multi-layered nanostructure of claim 24 with a solution comprising a zinc source, a selenium source, and a sulfur source;
(e) optionally repeating (d) to provide a multi-layered core/buffer layer;
(f) contacting the multi-layered core/buffer layer of (e) with a solution comprising a zinc carboxylate source and a sulfur source;
(g) repeating (f) to provide a multi-layered core/buffer layer/shell nanostructure.
